(19) United States
(12) Patent Application Publication
(10) Pub. No.: US 2007/0130344 A1
(43) Pub. Date: Jun. 7, 2007

(54) Using load balancing to assign paths to hosts in a network

(76) Inventor: Timothy C. Pepper, Tigard, OR (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/280,145

(22) Filed: Nov. 14, 2005

(51) Int. Cl. G06F 15/16

(52) U.S. Cl. 709/227

(57) ABSTRACT

Provided are a method, system and program for using load balancing to assign paths to hosts in a network. Host path usage information is received from hosts indicating host usage of paths to a target device. A load balancing algorithm is executed to use the received host path usage information to assign paths to hosts to use to communicate with the target device in a manner that balances path utilization by the hosts.

### BACKGROUND OF THE INVENTION

1. Field of the Invention

The present invention relates to a method, system, and program for using load balancing to assign paths to hosts in a network.

2. Description of the Related Art

Host systems in a storage network may communicate with a storage controller through multiple paths. The paths from a host to a storage controller may include one or more intervening switches, such that the switch may provide multiple paths from a host port to multiple storage controller ports.

In the current art, each host may determine the different paths, direct or via switches, that may be used to access volumes managed by a storage controller. The hosts may each apply a load balancing algorithm to determine paths to use to transmit I/O requests to a storage controller that are directed to volumes managed by the storage controller. One drawback with this approach is that if different hosts individually perform load balance using the same load balancing algorithm, then they may collectively overburden a portion of the storage network and underutilize other portions of the network.

For these reasons, there is a need in the art for improved techniques for assigning paths to hosts in a network environment.

### SUMMARY

Provided are a method, system and program for using load balancing to assign paths to hosts in a network. Host path usage information is received from hosts indicating host usage of paths to a target device. A load balancing algorithm is executed to use the received host path usage information to assign paths to hosts to use to communicate with the target device in a manner that balances path utilization by the hosts.

### BRIEF DESCRIPTION OF THE DRAWINGS

FIG. 1 illustrates an embodiment of a network computing environment.

FIGS. 2a and 2b illustrate embodiments for how paths may connect hosts to storage clusters.

FIG. 3 illustrates an embodiment of operations to assign paths to hosts in a network to use to access a storage controller.

FIG. 4 illustrates an embodiment of path usage information a host communicates to a network manger.

FIGS. 5 and 6 illustrate embodiments of operations to execute a load balancing algorithm.

### DETAILED DESCRIPTION

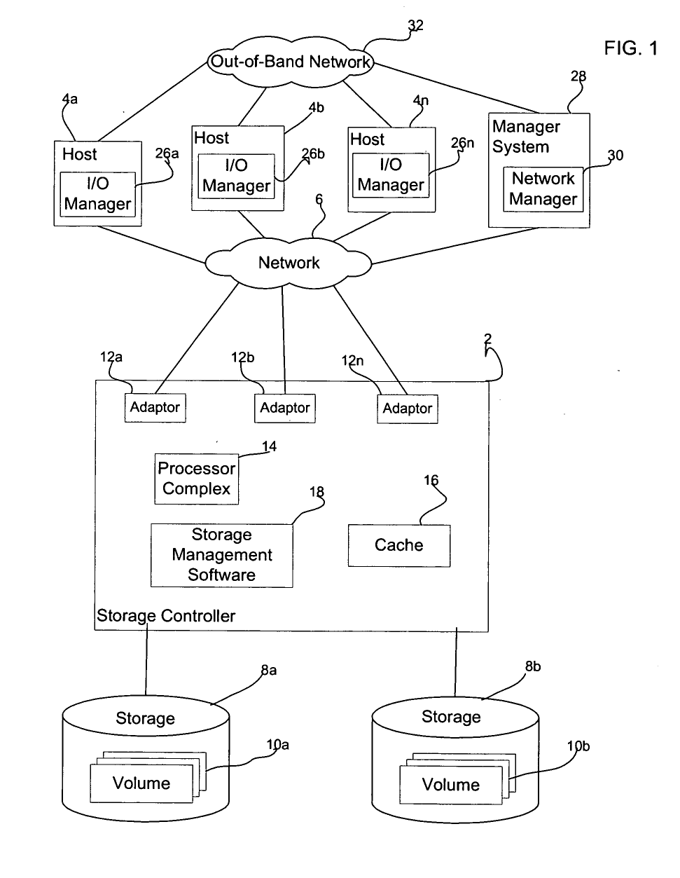

FIG. 1 illustrates an embodiment of a network computing environment. A storage controller 2 receives Input/Output (I/O) requests from host systems 4a, 4b . . . 4n over a network 6 directed toward storages 8a, 8b each configured to have one or more volumes 10a, 10b (e.g., Logical Unit Numbers, Logical Devices, etc.). The storage controller 2 includes a plurality of adaptors 12a, 12b . . . 12n, each including one or more ports, where each port provides an endpoint to the storage controller 2. The storage controller includes a processor complex 14, a cache 16 to cache I/O requests and data with respect to the storages 8a, 8b, and storage management software 18 to perform storage management related operations and handle I/O requests to the volumes 10a, 10b. The storage controller 2 may include multiple processing clusters on different power boundaries to provide redundancy. The hosts 4a, 4b . . . 4n include an I/O manager 26a, 26b . . . 26n program to manage the transmission of I/O requests to the adaptors 12a, 12b . . . 12n over the network 6. In certain embodiments, the environment may further include a manager system 28 including a network manager program 30 to coordinate host 4a, 4b . . . 4n access to the storage cluster to optimize operations.

The hosts 4a, 4b . . . 4n and manager system 28 may communicate over an out-of-band network 32 with respect to the network 6. The hosts 4a, 4b . . . 4n may communicate I/O requests to the storage controller 2 over a storage network 6, such as a Storage Area Network (SAN) and the hosts 4a, 4b . . . 4n and manager system 28 may communicate management information among each other over the separate out-of-band network 32, such as a Local Area Network (LAN). The hosts 4a, 4b . . . 4n may communicate their storage network 6 topology information to the manager system 28 over the out-of-band network 32 and the manager system 28 may communicate with the hosts 4a, 4b . . . 4n over the out-of-band network 32 to assign the hosts 4a, 4b . . . 4n paths to use to access the storage controller 2. Alternatively, the hosts 4a, 4b . . . 4n, manager system 28, and storage controller 2 may communicate I/O requests and coordination related information over a single network, e.g., network 6.

The storage controller 2 may comprise suitable storage controllers or servers known in the art, such as the International Business Machines (IBM®) Enterprise Storage Server® (ESS) (Enterprise Storage Server and IBM are registered trademarks of IBM®). Alternatively, the storage controller 2 may comprise a lower-end storage server as opposed to a high-end enterprise storage server. The hosts 4a, 4b . . . 4n may comprise computing devices known in the art, such as a server, mainframe, workstation, personal computer, hand held computer, laptop, telephony device, network appliance, etc. The storage network 6 may comprise a Storage Area Network (SAN), Local Area Network (LAN), Intranet, the Internet, Wide Area Network (WAN), etc. The out-of-band network 32 may be separate from the storage network 6, and use network technology, such as LAN. The storage 8a, 8b, may comprise an array of storage devices, such as a Just a Bunch of Disks (JBOD), Direct Access Storage Device (DASD), Redundant Array of Independent Disks (RAID) array, virtualization device, tape storage, flash memory, etc.

Each host 4a, 4b . . . 4n may have separate paths through separate adaptors (and possibly switches) to the storage controller 2, so that if one path fails to the storage controller 2, the host 4a, 4b . . . 4n may continue to access storage 8a . . . 8n over the other path and adaptor. Each adaptor may include multiple ports providing multiple end points of access. Further, there may be one or more levels of switches between the hosts 4a, 4b . . . 4n and the storage controller 2 to expand the number of paths from one host endpoint (port) to multiple end points (e.g., adaptor ports) on the storage controller 2.

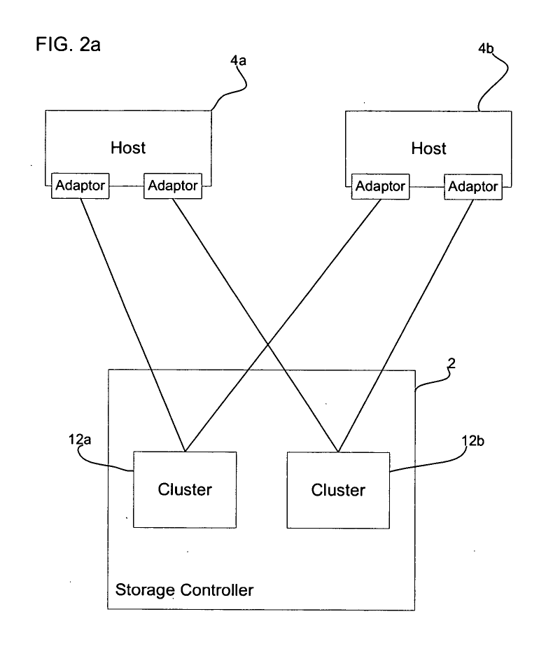

FIGS. 2a and 2b illustrate different configurations of how the hosts 4a and 4b and clusters 12a, 12b in FIG. 1 may connect. FIG. 2a illustrates one configuration of how the hosts 4a, 4b each have multiple adaptors to provide separate paths to the storage clusters 12a, 12b in the storage controller 54, where there is a separate path to each storage cluster 12a, 12b in each host 4a, 4b

FIG. 2b illustrates an alternative configuration where each host 4, 4b has one path to each switch 62a, 62b, and where each switch 62a, 62b provides a separate path to each storage cluster 12a, 12b, thus providing each host 4a, 4b additional paths to each storage cluster 12a, 12b.

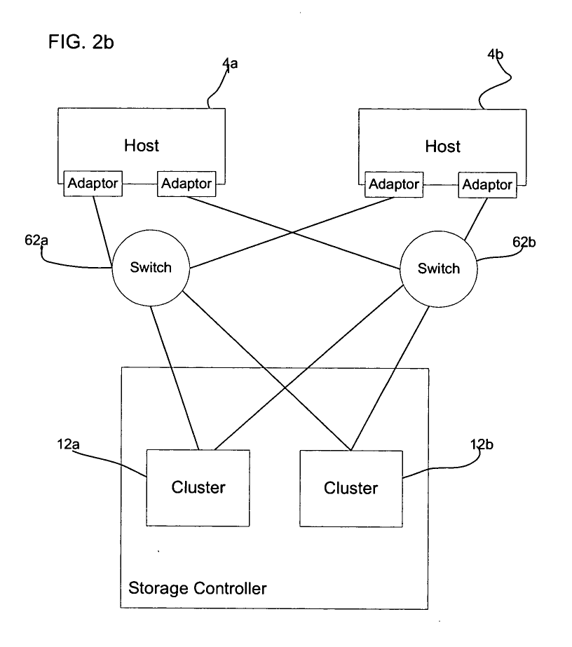

FIG. 3 illustrates an embodiment of operations implemented in the network manager 30 program of the manager system 28 to assign paths to hosts 4a, 4b . . . 4n to use to access the storage controller 2. The manager system 28 initiates (at block 100) operations to balance host assignments to paths. This operation may be performed periodically to update host path assignments to allow rebalancing for changed network conditions. The network manager 30 receives (at block 102) from each of a plurality of hosts 4a, 4b . . . 4n the number of I/Os each host has on each path to the storage controller 2. The number of I/Os may comprise a number of I/Os the host has outstanding on a path, i.e., sent but not completed, a number of I/Os transmitted per a unit of time, etc.

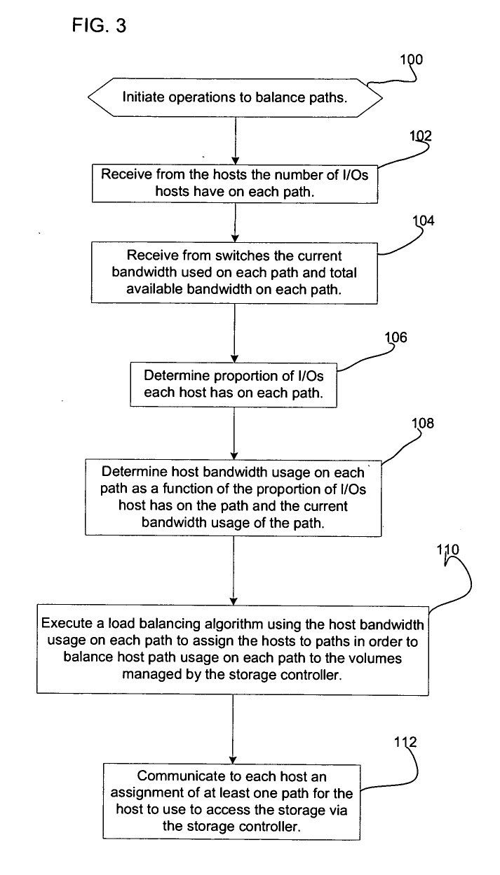

FIG. 4 provides an embodiment of information the hosts 4a, 4b . . . 4n may transmit to the manager system 28 for each path the host uses to communicate to the storage controller 2. For each path, the host path usage information 130 includes a host identifier 132, a host port 134 providing the host endpoint for the path, a storage controller port 136 providing the storage controller endpoint for the path (which may also include intervening switches), path usage 138, which may comprise a number of I/Os outstanding or for a measured time period, and a volume 140 to which the I/O is directed. A host 4a, 4b . . . 4n may use one path to access multiple volumes 10a, 10b The hosts 4a, 4b . . . 4n may transmit additional and different types of information to the manager system 28 to coordinate operations.

Returning to FIG. 3, the network manager 30 further receives (at block 104) information on the current bandwidth used on each path and total available bandwidth on each path. The path usage and bandwidth information may be provided by querying switches or other devices in the network 6. The network manager 30 determines (at block 106) the proportion of I/Os each host has on each path, which may be determined by summing the total I/Os all hosts have on a shared path and then determining each hosts percentage of the total I/Os on a path. The network manager 30 determines (at block 108) host bandwidth usage on each path as a function of the proportion of I/Os a host has on the path and the current bandwidth usage of the path. The network manager 30 may further consider host bandwidth usage on each subpath of a path if subpath information is provided for paths. Each subpath comprises an end point on a shared switch and an end point on another switch or a storage controller 2 port. In this way, the network manager 30 may consider each host's share of I/Os on each subpath between switches or between a switch and the storage controller 2. The network manager 30 executes (at block 110) a load balancing algorithm using the host bandwidth usage on each path or subpath to assign the hosts to paths in order to balance host path usage on each sub path to the volumes managed by the storage controller. The network manager 30 may use load balancing algorithms known in the art that consider points between nodes and their I/O usage weight to determine optimal path assignments between nodes to balance bandwidth usage. The network manager 30 may communicate (at block 112) to each host an assignment of at least one path for the host to use to access the storage via the storage controller. The path information communicated to the host may include the host end point (port) and storage controller end point (port) to use to communicate with the storage controller 2. Further, the load balancing algorithm may provide optimal path assignments per host and per volume. The network manager 30 may then communicate to each host 4a, 4b . . . 4n the assignment of paths each host may use to access a volume.

In certain embodiments, the path assignment may comprise a preferred path for the host to use to access the storage controller/volume. In one embodiment, if a host is not assigned a path to use to access a volume, then the host may not use an unassigned path. Alternatively, the host may use an unassigned path in the event of a failure. In further embodiments, different policies may be in place for different operating environments. For instance, if the storage network 6 is healthy, i.e., all or most paths are operational, then paths may be assigned to hosts, such that hosts cannot use unassigned paths unless they have no alternative. Whereas, if the network 6 has numerous failed paths, then certain hosts operating at lower quality of service levels or hosting less important applications may be forced to halt I/O to provide continued access to those hosts deemed having greater priority or importance, so that the performance of critical I/O does not suffer.

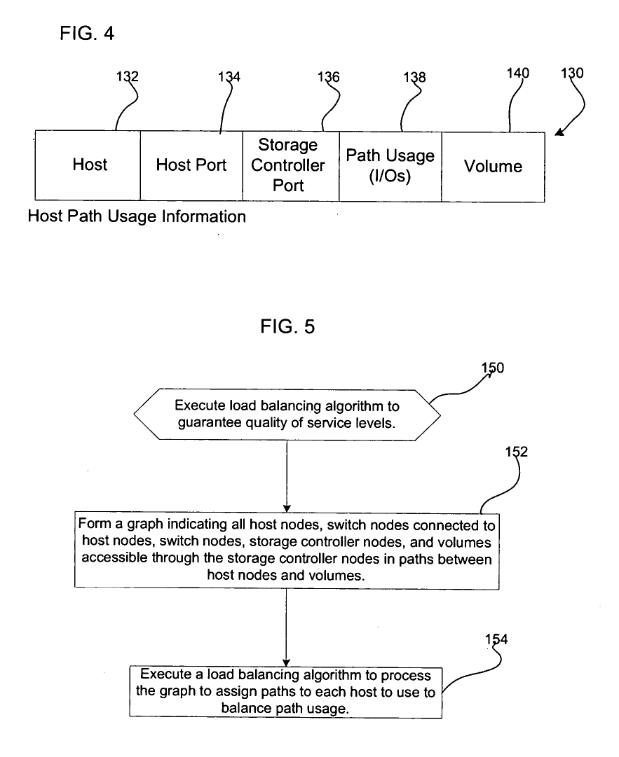

FIG. 5 illustrates an embodiment of operations performed by the network manager 30 to perform the load balancing operation at block 110 in FIG. 3. Upon initiating (at block 150) the load balancing algorithm, the network manager 30 forms in a computer readable memory (at block 152) a graph or map providing a computer implemented representation of all host nodes, switch nodes connected to the host nodes, switch nodes, storage controller nodes, and volumes accessible through the storage controller nodes in paths between host nodes and volumes in the network 6. The graph may be formed by the network manager 30 querying the host path usage information from the hosts 4a, 4b . . . 4n or the hosts 4a, 4b . . . 4n automatically transmitting the information. Similarly, information on switches and path bandwidth usage and maximum possible bandwidth may be obtained by the network manager 30 querying switches in the network out-of-band on network 32 or in-band on network 6. The network manager 30 then executes (at block 154) a load balancing algorithm, such as a multi-path load balancing algorithm, to assign paths to each host to use. As discussed, the network manager 30 may use path load balancing algorithms known in the art that process a graph of nodes to determine an assignment of paths to the hosts to use to access the volumes in storage. The graph may comprise a graph or mesh of nodes, vertexes, and edges and then apply standard partitioning and flow optimization algorithms to determine an optimal load balancing of hosts to paths. In further embodiments, an administrator may assign greater weights to certain hosts, volumes, or other network (e.g., SAN) components to assign or indicate preference in using certain network components.

In an additional embodiment, each host 4a, 4b . . . 4n may be assigned to a particular quality of service level. A quality of service level guarantees a certain amount of path redundancy and bandwidth for a host. Thus, a high quality of service level (e.g., platinum, gold) may guarantee assignment of multiple paths at a high bandwidth level and no single point of failure, whereas a lower quality of service level may guarantee less bandwidth and less or no redundancy.

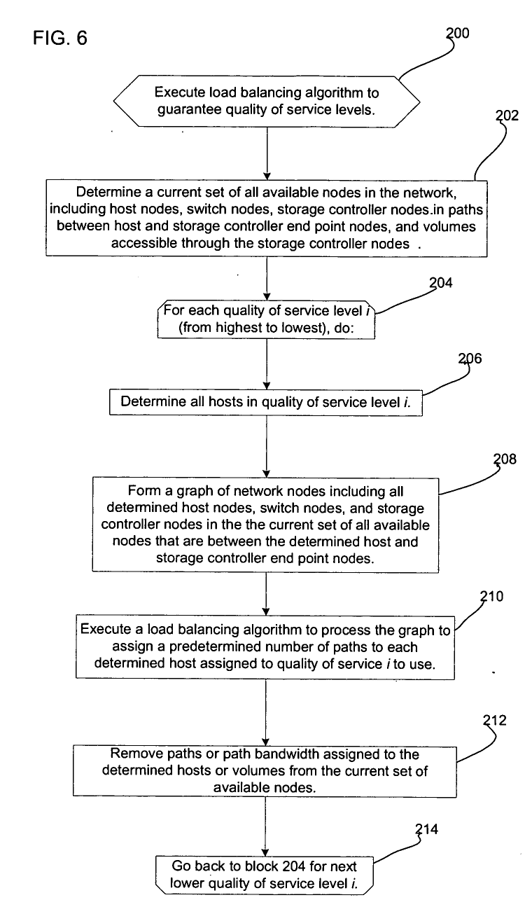

FIG. 6 illustrates an additional embodiment of operations performed by the network manager 30 to perform the load balancing operation at block 110 in FIG. 3 to take into account different quality of service levels for the hosts 4a, 4b . . . 4n. Upon initiating (at block 200) the load balancing algorithm, the network manager 30 determines (at block 202) a current set of all available nodes in the network, including host nodes, switch nodes, storage controller nodes in paths between host and storage controller end point nodes, and volumes accessible through the storage controller nodes. The network manager 30 then performs a loop of operations at blocks 204 through 214 for each quality of service level to which hosts 4a, 4b . . . 4n and/or volumes 10a, 10b . . . 10n are assigned. As discussed, a quality of service level may specify a number of redundant paths, level of single point of failures, and bandwidth. The network manager 30 may consider quality of service levels at blocks 204 through 214 from a highest quality of service level and at each subsequent iteration consider a next lower quality of service level. For each quality of service level i, the network manger 30 determines (at block 206) all hosts 4a, 4b . . . 4n and/or volumes 10a, 10b . . . 10n assigned to quality of service level i. A graph of network nodes is formed (at block 208) including all determined host nodes, switch nodes, and storage controller nodes in the current set of all available nodes that are between the determined host and storage controller end point nodes. For the highest quality of service, the current set of available nodes includes all paths in the network. The network manager 30 executes (at block 210) a load balancing algorithm to process the graph to assign a predetermined number of paths to each determined host assigned to quality of service i to use. The paths (e.g., one or more switch nodes and storage controller nodes) or path bandwidth assigned to the determined hosts or volumes are removed (at block 212) from the current set of available nodes. Control then proceeds (at block 214) back to block 206 to consider the next highest quality of service level for which to assign paths, with a smaller set of available paths, i.e., switch and storage controller nodes.

With the operations of FIG. 6, each quality of service level is associated with a group of paths such that the hosts assigned to that quality of service level may utilize those paths in the group for the level. In one embodiment, hosts in a lower quality of service level may not use a group of paths assigned to a higher quality of service level. However, hosts assigned to one quality of service level may use paths in the group of paths assigned to a lower quality of service level. In another embodiment, hosts are allotted no more than a specified portion of the bandwidth on a path or other network component and must limit themselves to not passing the indicated threshold.

Described embodiments provide techniques for load balancing path assignment across hosts in a storage network by having a network manager perform load balancing with respect to all hosts and paths to a target device, and then communicate path assignments for the hosts to use to access the target device.

### ADDITIONAL EMBODIMENT DETAILS

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

The described embodiments discussed optimizing paths between hosts 4a, 4b . . . 4n and one storage controller 2. In further embodiments, the optimization and load balancing may be extended to balancing paths among multiple hosts and multiple storage controllers, and volumes on the different storage controllers.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of FIGS. 3, 5, and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture including code capable of receiving information from a plurality of hosts over a network, wherein the hosts communicate with a target device over network paths, wherein the code is capable of causing operations to be performed, the operations comprising:
receiving host path usage information from hosts indicating host usage of paths to a target device; and
executing a load balancing algorithm using the received host path usage information to assign paths to hosts to use to communicate with the target device in a manner that balances path utilization by the hosts.

2. The article of manufacture of claim 1, further comprising:
receiving path bandwidth usage on paths to the target device, wherein the load balancing algorithm uses the received path bandwidth usage and the host path usage information to assign paths to hosts; and
communicating to each host an assignment of at least one path for the host to use to access the target device.

3. The article of manufacture of claim 2, wherein receiving path usage information comprises receiving from the hosts a number of Input/Output requests the host has on the path, wherein path bandwidth usage on the paths is received from at least one switch in the paths from the hosts to the target device, further comprising:
determining for each host and path used by the host the host bandwidth usage on the path as a function of a proportion of the I/O requests the host has on the path and the path bandwidth usage on the path, wherein the load balancing algorithm assigns hosts to paths to balance the host bandwidth usage of the paths.

4. The article of manufacture of claim 1, wherein the target device comprises a storage controller providing access to a storage in which a plurality of volumes are configured, wherein the hosts provide path usage information for each volume in the storage, wherein the load balancing algorithm balances path usage on a per volume basis, and wherein the assignment indicates an assignment of at least one path for the host to use to access a particular volume.

5. The article of manufacture of claim 1, further comprising:
maintaining quality of service information for the hosts, wherein the load balancing algorithm assigns hosts to one of a plurality of groups, wherein each group includes at least one path to access the target device, wherein each group is associated with one quality of service level and provides at least one path for the hosts associated with the quality of service level to use.

6. The article of manufacture of claim 5, wherein the communicated assignment for at least one host indicates at least one path the host cannot use to access the target device to reserve paths for hosts associated with a higher quality of service level than the quality of service level of the host.

7. The article of manufacture of claim 1, wherein executing the load balancing algorithm further comprises:
defining a graph indicating in a network all host nodes, switch nodes between host nodes and target device nodes, and target device nodes, where a path comprises one of the host nodes and one of the target device nodes, and wherein the load balancing algorithm processes the graph to determine the assignment of paths to the hosts.

8. The article of manufacture of claim 1, wherein each of the hosts is assigned to one of a plurality of quality service levels, and wherein executing the load balancing algorithm comprises:
performing iterations of load balancing for each quality of service level, starting form a highest quality to a lowest quality of service level, by load balancing with respect to available paths or bandwidth and hosts assigned to the quality of service for the iteration, wherein at each subsequent iteration the paths assigned to hosts during a previous iteration are removed from the available paths considered for assignment.

9. A system in communication with a plurality of hosts, wherein the hosts communicate over network paths to a target device, comprising:
a processor; and
a computer readable medium including code executed by the processor to perform operations, the operations comprising.
receiving host path usage information from the hosts indicating host usage of paths to the target device; and
executing a load balancing algorithm using the received host path usage information to assign paths to hosts to use to communicate with the target device in a manner that balances path utilization by the hosts.

10. The system of manufacture of claim 9, wherein the operations further comprise:
receiving path bandwidth usage on paths to the target device, wherein the load balancing algorithm uses the received path bandwidth usage and the host path usage information to assign paths to hosts; and
communicating to each host an assignment of at least one path for the host to use to access the target device.

11. The system of claim 10, wherein receiving path usage information comprises receiving from the hosts a number of Input/Output requests the host has on the path, wherein path bandwidth usage on the paths is received from at least one switch in the paths from the hosts to the target device, and wherein the operations further comprise:
determining for each host and path used by the host the host bandwidth usage on the path as a function of a proportion of the I/O requests the host has on the path and the path bandwidth usage on the path, wherein the load balancing algorithm assigns hosts to paths to balance the host bandwidth usage of the paths.

12. The system of claim 9, wherein the target device comprises a storage controller providing access to a storage in which a plurality of volumes are configured, wherein the hosts provide path usage information for each volume in the storage, wherein the load balancing algorithm balances path usage on a per volume basis, and wherein the assignment communicated to each host indicates an assignment of at least one path for the host to use to access a particular volume.

13. The system of claim 9, wherein the operations further comprise:
maintaining quality of service information for the hosts, wherein the load balancing algorithm assigns hosts to one of a plurality of groups, wherein each group includes at least one path to access the target device, wherein each group is associated with one quality of service level and provides at least one path for the hosts associated with the quality of service level to use.

14. The system of claim 9, wherein each of the hosts is assigned to one of a plurality of quality service levels, and wherein executing the load balancing algorithm comprises:
performing iterations of load balancing for each quality of service level, starting form a highest quality to a lowest quality of service level, by load balancing with respect to available paths or bandwidth and hosts assigned to the quality of service for the iteration, wherein at each subsequent iteration the paths assigned to hosts during a previous iteration are removed from the available paths considered for assignment.

15. A method, comprising:
receiving host path usage information from hosts indicating host usage of paths to a target device; and
executing a load balancing algorithm using the received host path usage information to assign paths to hosts to use to communicate with the target device in a manner that balances path utilization by the hosts.

16. The method of claim 15, further comprising:
receiving path bandwidth usage on paths to the target device, wherein the load balancing algorithm uses the received path bandwidth usage and the host path usage information to assign paths to hosts; and
communicating to each host an assignment of at least one path for the host to use to access the target device.

17. The method of claim 16, wherein receiving path usage information comprises receiving from the hosts a number of Input/Output requests the host has on the path, wherein path bandwidth usage on the paths is received from at least one switch in the paths from the hosts to the target device, further comprising:
determining for each host and path used by the host the host bandwidth usage on the path as a function of a proportion of the I/O requests the host has on the path and the path bandwidth usage on the path, wherein the load balancing algorithm assigns hosts to paths to balance the host bandwidth usage of the paths.

18. The method of claim 15, further comprising:
maintaining quality of service information for the hosts, wherein the load balancing algorithm assigns hosts to one of a plurality of groups, wherein each group includes at least one path to access the target device, wherein each group is associated with one quality of service level and provides at least one path for the hosts associated with the quality of service level to use.

19. The method of claim 15, wherein each of the hosts is assigned to one of a plurality of quality service levels, and wherein executing the load balancing algorithm comprises:
performing iterations of load balancing for each quality of service level, starting form a highest quality to a lowest quality of service level, by load balancing with respect to available paths or bandwidth and hosts assigned to the quality of service for the iteration, wherein at each subsequent iteration the paths assigned to hosts during a previous iteration are removed from the available paths considered for assignment.

20. A method, comprising:
receiving host path usage information from hosts indicating host usage of paths to a target device;
receiving path bandwidth usage on paths to the target device;
executing a load balancing algorithm using the received host path usage information and received path bandwidth usage to assign paths to hosts to use to communicate with the target device in a manner that balances path utilization by the hosts; and
communicating to each host an assignment of at least one path for the host to use to access the target device.
